(19) United States
(12) Patent Application Publication
(10) Pub. No.: US 2007/0168868 A1
(43) Pub. Date: Jul. 19, 2007

(54) Method and system for integrating calculation and presentation technologies

(75) Inventors: Richard M. Korzenko, Bay Shore, NY (US); Johnny J. Wong, Englewood Cliffs, NJ (US); Elie Majdalani, Jersey City, NJ (US)

Correspondence Address: Danie H. Golub, 1701 Market Street, Philadelphia, PA, 19103, US

(73) Assignee: LEHMAN BROTHERS INC., New York, NY (US)

(21) Appl. No.: 11/652,900

(22) Filed: Jan. 12, 2007

Related U.S. Application Data
(60) Provisional application No. 60/758,832, filed on Jan. 13, 2006.

(51) Int. Cl. G06F 3/00; G06F 17/00

(52) U.S. Cl. 715/732; 715/503; 715/730; 715/731; 715/530; 715/513

(57) ABSTRACT

A presentation is generated, and spreadsheets objects are embedded therein. The presentation may be customized prior to downloading. Mark-up language technology may be used in connection with the integration of spreadsheet and presentation technologies.

### COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to the integration of calculation and presentation technologies.

### BACKGROUND OF THE INVENTION

Many companies, including financial services companies, have the need to generate presentations, either for their own internal use or for providing to their clients. Presentations of this nature lend themselves to being created, and subsequently presented, using various forms of commercially available presentation software. Particularly in the financial services industry, the content of such reports often includes representations of financial or other numeric data, and calculations and modeling involving the same. Such calculations and modeling are easily manipulated using commonly used and available calculation software. There exists a need for a system and method that integrates the functionality of presentation software with that of calculation software to allow for the generation of such presentations in an efficient and flexible manner.

### SUMMARY OF THE INVENTION

The present invention is directed to a system and method for generating a presentation. A spreadsheet object is generated. The presentation is generated. In connection with generating the presentation, the spreadsheet object is embedded in the presentation.

The present invention is further directed to a system and method for customizing a presentation. The presentation, comprising one or more slides, is generated. An image of the slides is created. The images are displayed to a user. One or more requests to customize the presentation are received. A customized presentation is created.

The present invention is further directed to a system and method for generating a presentation. A request associated with generating a presentation is received. The request is parsed to determine one or more calculation actions and one or more presentation actions to be taken in connection with generating the presentation. A first mark-up language document is created, comprising executable instructions indicating calculation actions. The first mark-up language document is processed to create a second mark-up language document comprising calculation data. A third mark-up language document is created, comprising executable instructions indicating presentation actions. The third mark-up language document and the second mark-up language document are processed to create a fourth mark-up language document comprising data associated with one of a draft presentation and a final presentation.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIG. 1 is an illustration of one embodiment of a system of the present invention;

FIG. 2 is an exemplary workflow for the XML meta-language translator/interpreter;

FIG. 3 is an exemplary workflow for the calculation engine of the present invention;

FIG. 4 is an exemplary workflow for the presentation engine of the present invention;

FIG. 5 is a flowchart illustrating the steps that the user may undertake in using the present invention; and

FIGS. 6A, 6B and 6C are each a flow chart illustrating the steps of various methods of the present invention.

### DETAILED DESCRIPTION OF THE PREFERRED EMBODIMENTS

The system and method described herein integrate the functionality of presentation technology (such as MicroSoft PowerPoint, although other presentation technologies may be used within the scope of the present invention) with that of calculation technology (such as MicroSoft Excel, although other calculation technologies may be used within the scope of the present invention) to allow for the generation of presentations. The ability to leverage calculation technology allows for the inclusion of dynamic mathematical modeling (e.g., modeling of financial products) in such presentations. In a preferred embodiment, a user can preview and edit the presentation prior to the download of a write-protected proposal. Thus, the system allows for centrally managed control over the elements of the model and proposal content, while allowing selective customization options.

One way in which the described system and method are accomplished involves abstractly marrying calculation- and presentation-based technologies for the purpose of calculating models and building proposals. This enables rapid turn-around time for the generation of presentations, and empowered control over the content of such presentations. It further allows for various combinations of workflow to be achieved through manipulation or addition of configuration files and, if desired, templates; the products and outputs of the underlying calculation and presentation technologies may be chained together into a workflow to create complex product models and/or presentations. The decoupled design of this embodiment permits changes in the underlying calculation and presentation technology base, as well as the generation and retrieval of many different forms of output from the underlying technology bases.

A preferred embodiment of a system of the present invention includes a workflow management and control engine that integrates calculation and presentation technologies into a component-oriented framework supporting the dynamic calculation and presentation of mathematical models. The engine is driven by spreadsheet and presentation templates connected through mark-up language technology (e.g., XML-based technology) to create a highly configurable and flexible workflow. Spreadsheet-based modeling technology serves as the engine for making the calculations (e.g., figures and statistics) that are to be displayed in the presentation. This eases turnaround time for implementing updates in models. Presentation technology files may be used as templates. This eases turnaround time for implementing updates in the look and feel of the presentation. The engine is not specific as to its implementation, which allows for supporting the needs of multiple applications and/or changes in implementation of the underlying calculation and presentation technologies.

One mechanism for accomplishing the abstraction referred to above is to create a generalized, interpretive wrapper around each underlying technology component that processes instructions derived from an XML meta-language developed for each component. With each language/component geared toward its responsibility within the system and independent of the others, another XML meta-language is created that is geared toward managing the workflow required for producing models and presentations. The language elements contain lexicon for inducing the calculations/presentations processing, but add a new element for bridging the gap between the components (as each sub-component has its own independent language) by use of XSLT transformations. The workflow language induces XSLT transformations upon input of XML documents such that they may be manipulated into forms that each component can process. The lexical elements can be chained together in such ways that the output of one process can become the input into another by way of the transformation process. This provides a high degree of flexibility with regard to how the calculation routines may be chained together with other calculation routines, and/or presentation generating routines. These workflows reside in a configuration file that the system loads dynamically, and each workflow provides instruction as to how a model should be created. A great deal of diversity in the workflows can be achieved with minimal change to the system or meta-language.

The desired output of the system makes use of tables, charts rendered via the spreadsheet and embedded into the final presentation; several methods are acceptable for generating these, including OLE objects, including Chart Objects and Table Objects. Each of these types of objects is specific to MicroSoft technology; however, other types of similar technology will be known to those skilled in the art and can be used within the scope of the present invention.

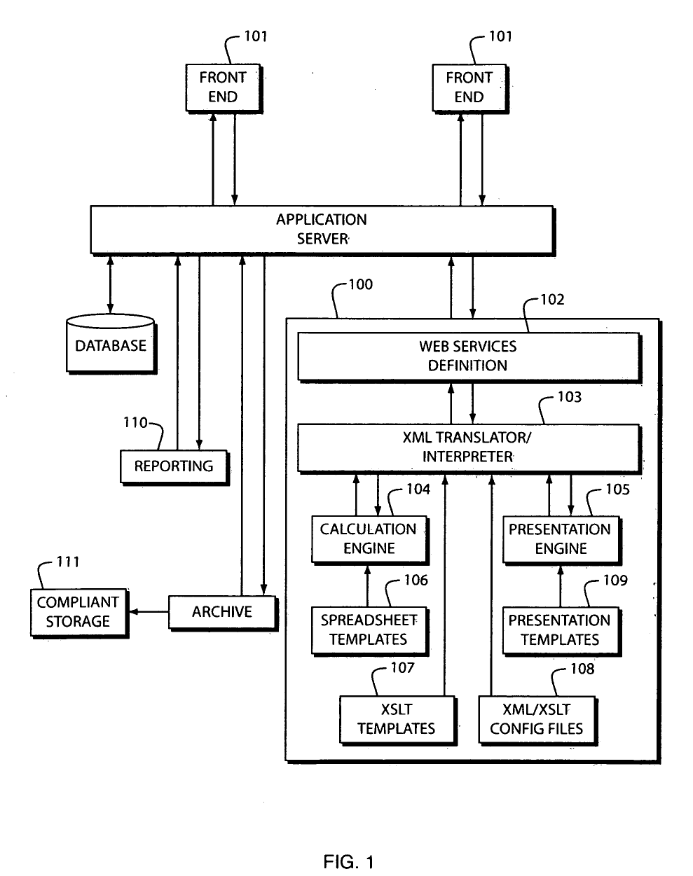

With reference to FIG. 1, a preferred embodiment of the system is structured into several components including a workflow management and control engine 100 and one or more front ends 101, corresponding to the various types of models. The engine 100 centrally hosts the logic for calculating and rendering product models while the front ends 101 serve as the network-based (e.g., Web-based) user interface for data entry of model parameters and viewing outputs (e.g., slide previews, presentation files etc.).

With continued reference to FIG. 1, in the preferred embodiment, the engine 100 is divided into five primary components: the web service definition tier 102 (which is comprised of a modeling service web service definition component and a presentation I/O web service definition component); the workflow engine/XML meta-language translator/interpreter 103; the calculation engine 104; the presentation engine 105; and configuration/template files, which are comprised of spreadsheet templates 106, presentation templates 109, XSLT templates 107, and XML/XSLT configuration files 108). The web service definition tier 102 is responsible for defining the web service definitions, fielding and parsing the incoming requests from the network, leveraging authentication for security over the endpoint, loading system configuration data on initiation of the service, handing over control of execution to the XML meta-language translator/interpreter 103, and returning whatever requested resource is required of the request. The XML meta-language translator/interpreter 103 is responsible for taking the incoming request, parsing the request to determine which model is to be generated or action is to be taken, loading the appropriate XSLT template(s) 107 to process the request, and forwarding control to the calculation engine 104 or presentation engine 105 when required. The calculation engine 104 accompanies the presentation engine 105 in the automation tier. It receives an XML document to process and produces a calculation technology file based on the instructions in that document. The presentation engine 105 accompanies the calculation engine 104 in the automation tier. It receives an XML document to process and produces a presentation technology file based on the instructions in that document. The configuration/template files 106, 107, 108 and 109 feed the XSLT, spreadsheet, and presentation components 103, 104 and 105. XSLT files 108 and 107 provide processing instructions for the automation tier while the spreadsheet templates 106 and presentation templates 109 provide baseline files from which to produce their respective final products. A more detailed explanation of each of these components is set forth below, after a discussion of the configuration files employed by the system.

In addition to the standard web project configuration file that specifies system configurations such as security, access and system properties that may be used throughout the system, the system also makes use of a configuration file 108 (referred to herein as amlconfig.xml) that contains global XSLT configuration parameters and the mappings of user requests to processing instructions (i.e., workflows), referred to herein as <map> elements.

The top of this configuration file contains XSLT configuration parameters that are loaded into every XSLT processing call, thus making them available as global XSLT configuration parameters. The second major section deals with mappings. After the <config> element, there can be one or more map elements. These <map> elements can contain any ordering of <transform>, <calc> and <pres> elements to create any workflow of XSLT transformation, calculation and presentation processing.

The following provides an example of a map:

```
...
<map id=“MPIAnalyzeRisk” modelId=“id” userId=“name”
organization=“organization”>
    <transform processor=
    “~\xsltFiles\calcXml\MPIAnalyzeRisk.calc.xsl”
    target=“calc1” />
    <calc name=“calc1” ></calc>
    <transform processor=“~\xsltFiles\resXml\MPIAnalyzeRisk.res.xsl”
    target=“res”/>
</map>
...
```

This map is interpreted as follows: when an XML request enters the system with the action value named “MPIAnalyzeRisk”, the system will transform that document with the “MPIAnalyzeRisk.calc.xsl” XSLT file into a series of processing instructions for the calculation engine 104 and then forward that document to the calculation engine 104 for processing/interpretation (specified via “<calc name=“calc1”></calc>”). The significance of the calculation engine 104's “name” attribute is covered in the next example. The calculation engine 104 processes the XML document as its elements dictate, producing a resource as instructed and/or generating values that are incorporated into the XML document that it is processing. After being processed by the calculation engine 104, the resulting XML document is transformed by the “MPIAnalyzeRisk.res.xsl” XSLT file which will produce an XML document to be sent back to the user with the results of the calculation process.

The following provides another example of a map:

```
...
<map id=“ FamLimPar2_1” modelId=“id” userId=“name”
organization=“organization”>
    <transform processor=“~\xsltFiles\calcXml\FamLimPar2_1.calc.xsl”
    target=“calc1” />
    <calc name=“calc1” ></calc>
    <transform processor=“~\xsltFiles\presXml\FamLimPar2_1.pres.xsl”
    target=“pres1”/>
    <pres name=“pres1”></pres>
    <transform processor=“~\xsltFiles\resXml\FamLimPar2_1.res.xsl”
    target=“res”/>
</map>
...
```

This more advanced map is interpreted as follows. When an XML request enters the system with the action named “FamLimPar2_{—}1”, the system will transform that document with the “FamLimPar2_{—}1.calc.xsl” XSLT file into a series of processing instructions for the calculation engine 104. The document is forwarded to the calculation engine 104 (specified via “<calc name=“calc1”></calc>”) for processing/interpretation. The calculation engine 104 is named calc1 and will only process those elements of the processing instructions, whereby the targeted elements are within a block with a “name” attribute that has a value of “calc1”. This is a manner of lightweight “namespacing” the actual calculation processing such that the engine can discriminate which parts of the instructions are to be processed/interpreted. In essence, the “namespacing” supports multiple iterations through the calculation engine 104 each time it processes/interprets different blocks by changing the name of the target of the transform element and the name of calc element, thereby avoiding redundant processing. An example of this is described below. After being processed by the calculation engine 104, the resulting XML document is transformed by the “FamLimPar2_{—}1.pres.xsl” XSLT file, and creates a new series of processing instructions for the presentation engine 105. The presentation again follows the same “namespacing” convention as applied to the calculation engine 104. The “<pres name=“pres1”></pres>” element signifies that those processing instructions in a block with the “name” attribute equal to “pres1” may be processed. The resulting document is then transformed by the “FamLimPar2_{—}1.res.xsl” XSLT file which will produce an XML document to be sent back to the user 101 with the results of the request.

A following provides another example of a map:

```
...
<map id=“FamLimPar2_5_1” modelId=“id”
    userId=“name” organization=“organization”>
    <transform processor=
    “~\xsltFiles\calcXml\FamLimPar25_2_1.calc.xsl” target=“calc1” />
    <calc name=“calc1” ></calc>
    <transform processor=
    “~\xsltFiles\calcXml\FamLimPar25_2_1.calc.xsl” target=“calc2 ” />
    <calc name=“calc2” ></calc>
    <transform processor=
    “~\xsltFiles\presXml\FamLimPar25_1.pres.xsl” target=“pres1”/>
    <pres name=“pres1”></pres>
    <transform processor=
    “~\xsltFiles\resXml\FamLimPar25_1.res.xsl” target=“res”/>
</map>
...
```

This more advanced map is interpreted as follows. When an XML request enters the system with the action equals “FamLimPar2_{—}5_{—}1”, the system transforms that document with the “FamLimPar25_{—}2_{—}1.calc.xsl” XSLT file into a series of processing instructions for the calculation engine 104 and then forwards that document to the calculation engine 104 (specified via “<calc name=“calc1”></calc>”) for processing/interpretation. As previously mentioned, the calculation engine 104 will only process those elements whereby the targeted elements are within a block with a “name” attribute that has a value of “calc1”. The next <transform> element transforms the resulting XML document with the “FamLimPar25_{—}5_{—}1.calc.xsl” XSLT file. This document will then again be forwarded to the calculation engine 104 (specified via “<calc name=“calc2”></calc>”) for processing/interpretation. However, this time, the calculation engine 104 will only process those elements whereby the targeted elements are within a block with a “name” attribute that has a value of “calc2”, ignoring any elements that are in a block with a “name” attribute that has a value of “calc1”.

After being processed by the calculation engine 104, the resulting XML document is transformed by the “FamLimPar2_{—}5_{—}1.pres.xsl” XSLT file, thereby creating a new series of processing instructions for the presentation engine 105. The “<pres name=“pres1”></pres>” element signifies that those processing instructions in a block wherein the “name” attribute equal to “pres1” may be processed. The resulting document is then transformed by the “FamLimPar2_{—}5_{—}1.res.xsl” XSLT file which will produce an XML document to be sent back to the user 101 with the results of the request.

These mappings are loaded and made available to the requests at the initiation of the system, i.e., when the first request arrives.

The illustrated embodiment of the web service definition tier 102 exposes the underlying functionality to consumers via SOAP over HTTP protocol. This channel of communication is virtually platform-independent, from an accessibility standpoint, and allows for the multiplexing of the engine's functionality through a few similar entrance points to perform a great deal of diverse processing. Primarily, this tier is responsible for authenticating arriving requests, as described in more detail below, and the marshalling of the incoming requests and the outgoing responses.

Requests and responses into and out of the underlying XML meta-language translator/interpreter 103 take the form of XML document messages. The operations exposed through a port type define more than one format (or data type of the method signature argument) for an incoming message from the network and are transformed accordingly to the argument type for the underlying XML tier. The incoming messages are passed along and validated, parsed and processed as defined in the amlconfig.xml configuration file 108 described above. Response messages can either return actual data represented in an XML structure or meta-data that point to files that are the byproduct of a request. These response messages can be one of two types, “draft” and “final”. Draft models return an XML response to the caller. Final is characterized by the XML response containing meta-data about a single file that was produced by the request and which should be returned to the caller. In this case, the response from the web method will not be XML, but a Base64 encoded binary return value, comprising the requested file. This is done to stream-line the processing of requests in which the result is a single file. Operations that handle final responses parse out the requisite meta-data, construct the appropriate file path and return the file to the requesting user.

The following provides exemplary service definitions and accompanying exposed definitions that help to illustrate an example of how the web service definition tier 102 operates.

WmtModelingTool.asmx: This service definition serves as the primary entry point to the modeling functionality. The following are the exposed operations for the WmtNodelingTool portType definition:

BuildDraftAssetModelStr: This operation serves as a web-enabled proxy to the underlying XML meta-language translator/interpreter 103 for generating, in this example, asset models. This is an RPC method with arguments defined in SOAP RPC-encoding, taking a single String parameter as an argument. The string parameter is an XML message constructed by the client that is passed to the XML meta-language translator/interpreter 103. The operation returns a String encoded, XML message in response (i.e., returned from XML meta-language translator/interpreter 103).

BuildDraftAssetModelXml: Like the previous operation, this operation serves as a web-enabled proxy to the underlying XML meta-language translator/interpreter 103. This is an RPC method with arguments defined as Document Literal, taking a single XML document as an argument. The XML message constructed by the client is passed to the XML meta-language translator/interpreter 103. The operation returns an XML message in response (i.e., returned from XML meta-language translator/interpreter 103).

BuildFinalAssetNodelStr: This operation serves as a web-enabled proxy to the underlying XML meta-language translator/interpreter 103. This is an RPC method with arguments defined in SOAP RPC-encoding, taking a single String parameter as an argument. The string parameter is an XML message constructed by the client that is passed to the XML meta-language translator/interpreter 103. The operation of the underlying XML meta-language translator/interpreter 103 returns an XML message, which is parsed for meta-data about the resulting file produced by the request that is returned to the caller.

BuildFinalAssetModelXml: Like the previous operation, this operation serves as a web-enabled proxy to the underlying XML meta-language translator/interpreter 103. This is an RPC method with arguments defined as Document Literal, taking a single XML document as an argument. The XML message constructed by the client is passed to the XML meta-language translator/interpreter 103. The operation of the underlying XML meta-language translator/interpreter 103 returns an XML message, which is parsed for meta-data about the resulting file produced by the request that is returned to the caller.

MergeModelsStr: This operation serves as a web-enabled proxy to the underlying XML meta-language translator/interpreter 103 for merging multiple models. This is an RPC method with arguments defined in SOAP RPC-encoding, taking a single String parameter as an argument. The XML message constructed by the client that is passed to the XML meta-language translator/interpreter 103. The operation returns a String encoded, XML message in response.

MergeModelsXml: This operation serves as a web-enabled proxy to the underlying XML meta-language translator/interpreter 103 for merging multiple models. This is an RPC method with arguments defined as Document Literal, taking a single XML document as an argument. The XML message constructed by the client is passed to the XML meta-language translator/interpreter 103. The operation returns an XML message in response.

ReloadModelingToolConfig: This is a utility method for reloading the amlconfig.xml file. This is an RPC method with arguments defined in SOAP RPC-encoding, taking a single String parameter as an argument. The string is the name and location of a property file containing map definitions that are (re-)loaded by the operation; if the string is either null or empty, the current amlconfig.xml file is reloaded. This is a mechanism for refreshing the system's map entries or loading alternative entries. The operation returns a String “Success” or “Failure”<message> on completion.

WmtPresentationIO.asmx: This service definition provides ancillary operations that support the modeling functionality. The following are the exposed operations for the WmtPresentationIO portType definition:

DownloadPresentationSlideImage: This operation allows the caller to retrieve a binary image of a slide generated by the presentation engine 105 underlying the XML meta-language translator/interpreter 103. The web method is RPC taking a single String as an argument. The String argument is the meta-data path to the binary resource being requested. The operation returns a Base64 encoded binary response.

DownloadPresentation: This operation allows the caller to retrieve a presentation generated by the presentation engine 105 underlying the XML meta-language translator/interpreter 103. The web method is RPC taking a single String as an argument. The String argument is the meta-data path to the binary resource being requested. The operation returns a Base64 encoded binary response.

UploadPresentation: This operation allows the caller to upload presentations to be used in model merging operations by the underlying XML meta-language translator/interpreter 103. The web method is RPC taking a String argument for organization, a String userid, a String presentation name and a Base64 encoded Binary file (byte) that will be cached for the merge operations. The operation returns a String XML message containing meta-data for use by the caller to reference the cached proposal in subsequent merge operations.

The XML meta-language translator/interpreter 103 contains the intelligence behind processing requests. In essence, it is a workflow management engine that processes user requests according to system configurations contained in the amlconfig.xml configuration file 108 described above. Its responsibilities include: parsing and validating incoming XML documents for required elements/attributes; determining the line of execution to be taken by discriminating the incoming requested action against the configuration file entries; managing configured XSLT transformations that the XML request will undergo throughout the defined workflow; managing the synchronization requirements of multiple threads accessing the calculation engine 104 and presentation engine 105; managing and responding to error conditions arising from improper configurations, calculation engine 104 and presentation engine 105 processing time-outs and errors propagated up from the calculation engine 104 and presentation engine 105; synchronizing cached resources generated by the calculation engine 104 and presentation engine 105 locally and with the network share 110; and returning meta-data about the results of the request.

This tier is a singleton instance that is initialized once. System properties, loaded from the web service definition tier 102 and stored in the hosting environment, provide a location for the amlconfig.xml configuration file 108 containing the entries that govern all workflows that this tier will handle. The file is loaded once into an XML document that is stored as a static member.

An incoming XML request enters this tier via an XML document processing request. The key to processing the request is the structure of the incoming XML document; the contents of the attributes dictate the workflow to be undertaken and the input data to be processed therein. The outer most element, referred to as <modelRequest> for illustrative purposes, is the document root and contains several attributes. As an illustrative example (i.e., more or less attributes may be required in accordance with other embodiments of the invention), three attributes are required: action, the name of the model (i.e., action, model name, workflow, <map> id are used synonymously herein); userid, the userid for whom the products of the workflow are being generated; and organization, the organization to which that the user belongs. For example: <modelRequest action=“FamLimPar2_{—}1” userId=“rkorzenk” organization=“LB”>

The next block of the document contains the input fields that are required of the various models, as shown in the following example:

```
<inputFields>
    <field name=“client” value=“rkorzenk” />
    <field name=“date” value=“August 9, 2005” />
    <field name=“asset” value=“Lehman Stock” />
    <field name=“shares” value=“1000000” />
    <field name=“price” value=“10” />
    <field name=“discount” value=“” />
    <field name=“value” value=“10000000.00” />
    <field name=“rate” value=“0.048000” />
    <field name=“rateTerm” value=“August 2005” />
    <field name=“term1” value=“2” />
    <field name=“term2” value=“−1” />
    <field name=“growth1” value=“0.10000000” />
    <field name=“growth2” value=“−1” />
</inputFields>
```

These elements are generic in structure, but become model-specific with regard to the values of the attributes. This allows for the transparent processing of multiple models at a general level. As validation can be over-bearing for this tier, it is the calling application's responsibility (e.g., an application on front end 101) to ensure the validity of the data, in one embodiment. This tier processes the input data as posted until an error condition occurs or the model completes, accurately or not.

The final section offers the general inclusion of options for processing the model, as shown in the following example:

```
    ...
    <opts>
        <opt name=“format” value=“draft” />
    </opts>
</modelRequest>
```

The format option has a system-wide meaning, as described above with in connection with the web services definition tier. It has specific implications at both the model-specific and workflow-processing levels.

Returning to the request processing lifecycle with a previously referenced example, “FamLimPar2_{—}1”, three attributes of the <modelRequest> element are parsed upon entry into this tier and used to discriminate the amlconfig.xml file for the appropriate <map> entry that will process the request. The value of the action attribute must correspond to a name attribute in a map element. That map element will contain transform, calc and pres instructions and templates that this tier will use to handle the request. As the name attribute is DTD defined as an ID, it must be unique among the other entries. Failure to find an appropriate <map> element will raise an error condition and processing will terminate.

In this case, the “FamLimPar2_{—}1” action will correspond to the map named “FamLimPar2_{—}1”. Once the <map> node is located, two copies are be made. The first copy of the node, the “roadmap”, will serve to govern the workflow this tier uses to process the request. The <map> node instructions will be iterated through in sequence and processed as the underlying elements (i.e., <transform>, <calc> and <pres>) dictate. The second copy of the node will be used as the target of any XSLT <transform> instructions and, in turn, a vehicle for all data that is used throughout the <map>'s defined workflow. This, with the help of <map> namespacing, allows for data to be passed as needed from instruction to instruction within the map and processed as needed.

Upon locating and cloning the appropriate <map> elements, the <field> elements are pulled from the request and placed into a Name/Value Map as the name and value attributes dictate. This map is supplemented with the <prop> name/value pairs nested within the <config> element of the amlconfig.xml configuration file 108. The resulting name/value map is used by this tier to load external parameters to <transform> instructed XSLT processing. The serves to allow a generic way of providing the input fields to the model-specific XSLT processing such that the sheets may subscribe to these parameters as needed and are pervasive throughout all transformations. This simplifies the actual XSLT stylesheets that are used such that they may address the greater purpose of building an XML document that can be processed by the calculation engine 104 and/or the presentation engine 105. As discussed previously, the output of these transformations typically will be an XML document that will serve as a set of instructions for either the calculation engine 104 or the presentation engine 105.

Continuing with the current example, after the <map> clones and the name/value map are created, the “roadmap” clone is passed to a SAX parser which will iterate through all the <transform>, <calc> and <pres> within the <map>.

```
...
<map id=“ FamLimPar2_1” modelId=“id” userId=“name”
organization=“organization”>
    <transform processor=“~\xsltFiles\calcXml\FamLimPar2_1.calc.xsl”
    target=“calc1” />
    <calc name=“calc1” ></calc>
    <transform processor=“~\xsltFiles\presXml\FamLimPar2_1.pres.xsl”
    target=“pres1”/>
    <pres name=“pres1”></pres>
    <transform processor=“~\xsltFiles\resXml\FamLimPar2_1.res.xsl”
    target=“res”/>
</map>
...
```

<map>: A working directory is created off the root specified in the location specified by the SYSPmodelRoot property in the amlconfig.xml configuration file 108. The structure is then ˜/organization/userid/modelid where the model id is the current system ticks value. This directory will hold (i.e., cache) all files generated by the workflow.

Ex: ˜/b/rkorzenk/632591966329322027

<transform>: When this node is encountered, the system will pass the source code clone into an XSLT transformation using the stylesheet named within the processor attribute. The system will also pass in the name/value map as mentioned previously, making the input fields and config fields readily available to the transformation. The output document is collected and moved to the next step. The system will also grab and hold a reference to the value of the target attribute. In this example, the source code document is transformed with the “FamLimPar2_{—}1.calc.xsl” stylesheet, which will produce a set of executable instructions for the next element, <calc>, to process.

<calc>: This element instructs the system to pass the executable instructions document (i.e., the result of the previous transformation) to the calculation engine 104 for processing. It will do so after interrogating the name attribute of the <calc> element. If the name matches the target captured in the previous transformation, it will honor the request. This rule is in place to ensure that at least one transformation occurs before a calculation occurs, as there is no other way to build a set of instructions that the calculation engine 104 can understand and process successfully. The document is passed in by reference; thus, any alterations occurring inside the calculation engine 104 affect the executable instructions directly. It is also important to note that only a single thread will access this functionality at a given time. Referring again to the running example, the calculation engine 104 will take over and process the document as instructed in the executable instructions document.

<transform>: This element is the next to be processed in this example as previously indicated, passing the output document from the <calc> call to an XSLT transformation using the “FamLimPar2_{—}1.pres.xsl” XSLT stylesheet. The resulting executable instructions document is passed to the next element, <pres> to be processed.

<pres>: This element instructs the system to pass the executable instructions document (i.e., the result of the previous transformation) to the presentation engine 105 for processing. It will do so after interrogating the name attribute of the <pres> element. If the name matches the target captured in the previous transformation, it will honor the request. This rule is in place to ensure that at least one transformation occurs before a presentation occurs. The document is passed in by reference; thus, any alterations occurring inside the presentation engine 105 affect the executable instructions directly. It is also important to note that only a single thread will access this functionality at a given time.

<transform>: This element is the last to be processed in this example, as previously indicated, passing the output document from the <pres> call to an XSLT transformation using the “FamLimPar2_{—}1.res.xsl” XSLT stylesheet. The resulting document is the last in the workflow chain and is now returned as the response XML document to the web service definition tier 102 and, ultimately, to the caller.

The foregoing example provides a typical workflow for illustrative purposes; simpler or more advanced workflows can be configured within the scope of the present invention. Within the rules that are set is a great deal of flexibility to manipulate any form of office or non-office document as configurable via this tier.

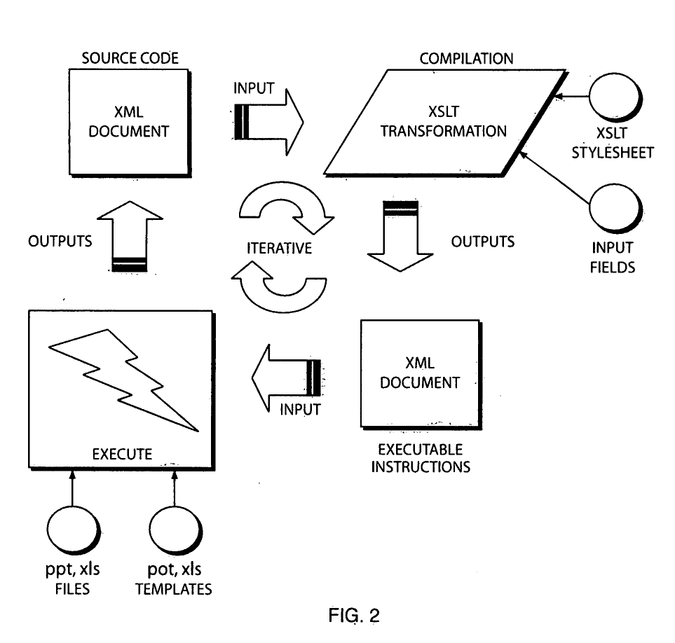

FIG. 2 illustrates the exemplary process described above. The <Map> XML document is input into the XSLT transformation (supplemented by the input fields) in a manner that is analogous to the way in which source code is input into a compiler. Here, it is transformed into executable instructions that the calculation engine 104 or presentation engine 105 can perform. The instructions are then executed by the calculation engine 104 or presentation engine 105 (in some embodiments, supplemented by the spreadsheet templates 106 and presentation templates 109). The output is comprised of whatever products the instructions demand be created and/or manipulated by adding new data/values to its elements. Upon completion of execution, the instructions (i.e., the XML document) may then be used as input into another transformation or returned to the caller.

The calculation engine 104 is an XML interpreter wrapping around a calculation technology base for the purpose of providing a generalized abstraction to generate all means of outputs available from the underlying spreadsheet base. XML documents are passed by reference to the engine whereby they are executed like instructions. A SAX parser is employed to sequentially iterate through the input XML document (i.e., executable instructions) and process the elements it understands.

The premise of the calculation engine 104 is that the underlying calculation technology base's template file is a component that carries out the actual modeling, thereby allowing a decoupled structure whereby the model may be updated merely by replacing the template with an updated template. The engine is non-specific in its processing of financial models and may be leveraged for any type of modeling/calculation routine or data transformation that can be implemented by the underlying calculation technology. The engine will require little, if any, changes in order to accommodate new models/service/product offerings, given that the only requirement will be to add new templates and new XSLT files for preparing the instructions for processing them.

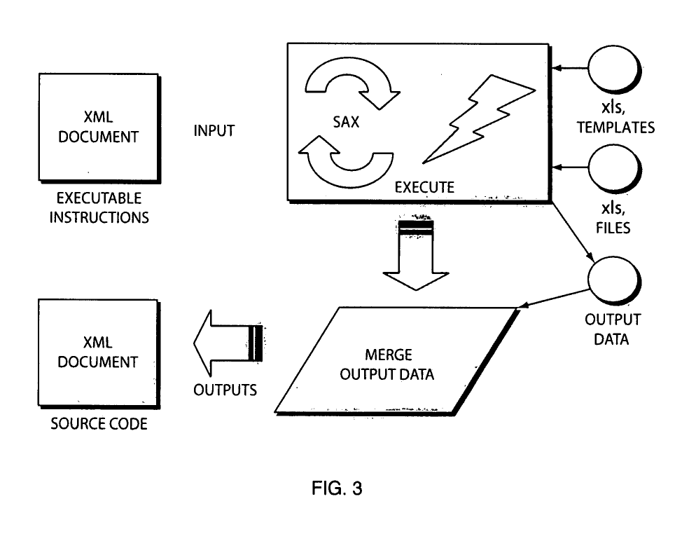

FIG. 3 illustrates an exemplary calculation engine 104 workflow. A set of executable instructions in the form of an XML document enters the system with the name of the target for the calculation routine. The document is then passed to a SAX parser that, based on the elements inside the XML document, will perform specific functions. These functions will only be executed when the parser comes across a <calc> element in which the name attribute of the element matches the target that was passed into the engine. When the SAX parser executes, it will process the elements as in the following example.

<calc>: The name attribute provides a “namespace” for its underlying data. The input attribute names the spreadsheet template file that should be used. The output attribute provides the name that the spreadsheet file should be saved as upon completion. When this element is encountered, the system will check to see if the target is the same as the name attribute. If it is, it will set a flag that tells the system to process the nodes to come until the </calc> tag is encountered. The template file named in the input attribute will be opened and used for processing and saved as the value of the output attribute when the </calc> tag is encountered. For example:

<calc name=“calc1” input=“D:\Documents\XamlConfig\
Templates_S\FamLimPar2_1.calc.xls”output=“D:\
Documents\XamlConfig\Models\LB\rkorzenk\
632591966329322027\FamLimPar2_1.xls”
error=“false”>

<cell>: This element is the only child node under a <calc> node that will be processed. This cell can either place a value into a cell in a given worksheet or extract a value from a given worksheet. The sheet attribute tells the engine upon which worksheet to execute this instruction. The cell attribute names the cell that is the target of the instruction on the given sheet. The value attribute provides the actual value that should be placed in the cell, in cases of inserting data, and serves as a placeholder when extracting data. The type attribute can hold a value of either “in” or “out”, which tells if the instruction is either inserting or extracting. When a type is extracting (i.e., “out”), the value of the cell on the sheet named will be placed into a name/value map using the name attribute of the <cell> element as a key. The name attribute provides a name for the field (i.e., cell) being processed and must be kept unique across all the sub-children of a given <calc> element. The names can overlap provided that the <cell> elements reside under different <caic> elements with different name attributes. For example:

<cell type=“in” name=“asset” sheet=“FLP2ASM” value=“Lehman
Stock” cell=“B6”></cell>
<cell type=“out” name=“grantorValue” sheet=“FLP2” value=“”
cell=“D7”>

On completion, the spreadsheet file is saved in the working directory that was created by the XML meta-language translator/interpreter 103, which is the directory named in the <calc> element's input attribute. The engine will then take any/all output fields gathered into the name/value map during the SAX cycle and merge them into an XML document by locating the <cell> element (where the name attribute matches the key from the name/value map and the <calc> element's name attribute is that of the target being processed) and placing the value into the <cell> elements's value attribute. The document is then returned to the XML meta-language translator/interpreter 103.

The presentation engine 105 is an XML interpreter wrapping around a presentation technology base for the purpose of providing a generalized abstraction to the generation outputs available from the underlying presentation technology. XML documents are passed by reference to the engine where they are executed like instructions. A SAX parser is employed to sequentially iterate through the input XML document (i.e., executable instructions) and process the elements that it understands.

The premise of this engine is that the underlying presentation technology base's template file is a component that carries out the actual rendering, thereby allowing a decoupled structure pursuant to which presentations may be updated merely by replacing the template with an updated template. The engine is non-specific in its production of presentations and may be leveraged for any type of presentation output that can be rendered by the underlying presentation technology. The engine will need little, if any, changes in order to accommodate new presentations given that the only requirement will be to add new templates and new XSLT files for preparing the instructions for processing them.

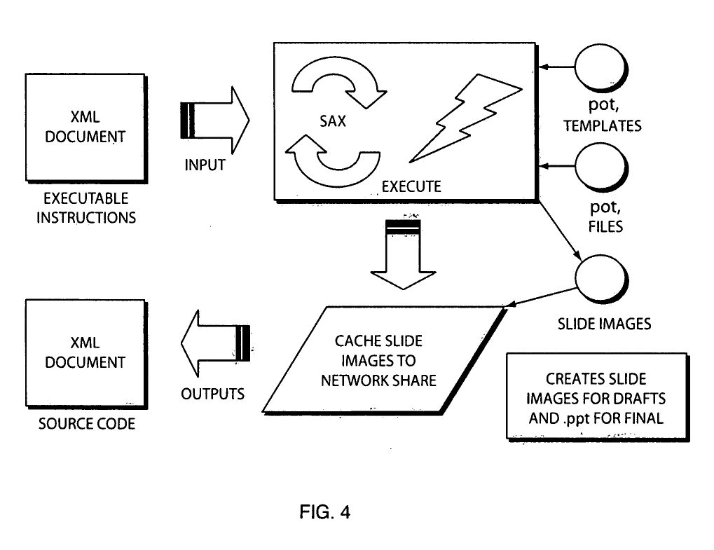

FIG. 4 illustrates an exemplary workflow for the presentation engine 105. A set of executable instructions in the form of an XML document enters the system with the name of the target for the presentation routine. The document is then passed to a SAX parser which, based on the elements inside the XML document, will perform specific functions. These functions will only be executed when the parser comes across a <pres> element in which the name attribute of the element matches the target that was passed into the engine. When the SAX parser executes, it will process the elements as follows:

<pres>: The name attribute provides a namespace for its underlying data. The input attribute names the PowerPoint template file that should be used. The output attribute provides the name that the PowerPoint file should be saved as upon completion. When this element is encountered, the system will check to see if the target is the same as the name attribute. If it is, it will set a flag that tells the system to process the nodes to come until the </pres> tag is encountered. The template file named in the input attribute will be opened and used for processing and saved as the value of the output attribute when the </pres> is encountered.

The format attribute, as referenced by the XML meta-language translator/interpreter 103, denotes whether the presentation is a draft or a final presentation. This tier translates as to whether the presentation file will be saved a series of slide images, in the case of a draft, or a presentation file, in the case of a final format. The image format corresponds to an image type supported by the underlying presentation technology and will be used only in the case of a draft presentation (e.g., .gif, .jpg, .png). Drafts offer the option of caching the slide images to a network share 110 for availability in a clustered environment. The simple inclusion of a noCache attribute, regardless of value, may be included to alert the engine that slide images are not to be cached to the network share. Alternate formats may be included in this attribute, such as .pps and .ppt (even though it is primarily for image formats) and they will be honored, thus not creating images.

By default, final presentations are password protected with a system configurable password. Final presentations are stored in compliant storage 111. This feature may be toggled off by the inclusion of a lockFile attribute, regardless of value. This element will have one or more <slide> elements. For example:

<pres name=“pres1” input=“D:\Documents\XamlConfig\Templates_P\
FamLimPar2_1.pres.pot” output=“D:\Documents\XamlConfig\Models\
LB\rkorzenk\632591966329322027\FamLimPar2_1.ppt” format=“draft”
imageFormat=“PNG” error=“false”>

<slide>: This element references the slide within the presentation that is going to be processed. The number attribute must correspond to the index of the slide in relation to the other slides; thus, it is unique. The showMe attribute is optional and denotes whether the slide should be included in the final presentation (the default is true). The showSlideNum attribute is optional and denotes whether a slide number should be placed on the current slide (the default is false). The number will be the slide's number in the new presentation (calculated as all slides less removed slides). This element may contain any of the remaining elements, by way of example:

<slide number=“1” showMe=“true” showSlideNum=“false”>

<swap>: This is tag is a child element of the <slide> element and effects only the slide indexed in that element. It is the most common operation available. This tag instructs that the text in an existing textbox element located at the attribute index be replaced with the value attribute's value. The name attribute does not need to be unique and serves as a reference to assist in visually associating an existing textbox element with the instruction beyond the index. When creating a presentation, it is more efficient and accurate to lay out the attributes visually and reference them by index to swap in replacement text as opposed to adding more overhead with creating it and setting the text. The name can be a temporary placeholder that assists greatly in positioning the elements and associating the instruction with the element. For example:

<swap index=“1” name=“@ @ @ CLIENT_NAME @ @ @” value=“rkorzenk”></swap>

<ole>: This tag instructs that an ole object residing at the path attributes value positioned at the top and left attributes values (must be integer >0), have a size of the height and width attributes values (must be integer >0), and may be cropped on ay side by any of the cropTop, cropLeft, cropRight and cropBottom attributes values (must be integer >0). Positioning is absolute from the top left corner by pixel. The size is in pixels and will vary with the ole object being embedded. The size may also be subject to holding aspects constant to which only the height or width will need to be set, as the other is a ratio of the value. The crop functions will also vary with the actual ole object as well. The order of honoring the setting is first crop image from original size then size the image followed by position the object. For example:

<ole
path=“D:\Documents\XamlConfig\Models\LB\
rkorzenk\6325919663293220\FamLimPar2_1.xls ”
top=“105” left=“55” height=“270” cropTop=“700”
cropLeft=“50” cropRight=“30”
cropBottom=“11” > </ole>

<textBox>: This tag adds a text box to the current slide having an orientation equal to the orientation attribute [“Down”, “Horizontal”, “Mixed”, “Vertical”, “Upward”] and constructed at the top and left attributes values (must be integer, default 0), having a size of the height and width attributes values (must be integer, default 1) and having a text value of the text attribute. For example:

<textBox orientation=”Down” top=“105” left=“55” height=“270”
width=“100” text=”Some text” ></textBox>

<emptyPresentation>: This tag will load a blank presentation if no template is to be used. For example:

<emptyPresentation/>

<template>: This tag will apply a template located in the path attribute's value to current presentation. For example:

<template path=“template”/>

<blankSlide>: This tag will add a Blank slide at the index specified in the number attribute. For example:

<blankSlide number=“3”/>

<titleSlide>: This tag will add a Title slide at the index specified in the number attribute. For example:

<titleSlide number=“3”/>

<label>: This tag will add a label to the current slide having an orientation equal to the orientation attribute [“Down”, “Horizontal”, “Mixed”, “Vertical”, “Upward”] and constructed at the top and left attributes values (must be integer, default 0); having a size of the height and width attributes values (must be integer, default 1); and having a text value of the text attribute. For example:

<label orientation=”Down” top=“105” left=“55” height=“270”
width=“100” text=”Some text”></label>

<line>: This tag will add a line to current slide e with a starting point at startX attribute by the startY attribute and ending point at endX attribute by the endY attribute. For example:

<line beginX=“105” beginY=“55” endX=“270” endY=“100”></line>

<title>: This tag will add a title to the current slide and a text value of the text attribute. For example:

<title text=“Some text”></title>

<shape>: This tag will add a shape to the current slide having an shape type equal to the shapeType attribute [“Rectangle”, “Oval”, “rtTriangle”, “is Triangle”, “Upward”] and constructed at the top and left attributes values (must be integer, default 0) and having a size of the height and width attributes values (must be integer, default 1). For example:

<shape shapeType=“Rectangle” top=“105” left=“55” height=“270” width=“100”></shape>

On completion, the presentation file is saved in the working directory that was created by the XML meta-language translator/interpreter 103, which is the directory named in the <pres> element's input attribute. For draft presentations, the slide images generated will be cached locally in the working directory and replicated out to a network share 110 if the noCache attribute of the target <pres> element is not present. The same meta-data used to create the working directory will be employed to create a working directory on the share 110. For final presentations, the file is saved as .ppt in the working directory and, ultimately 111, if desired. The document is then returned to the XML meta-language translator/interpreter 103.

The key to the decoupled structure of the application is its reliance on XSLT for transforming requests and dynamically creating application-specific instructions for the calculation engine 104 and presentation engine 105 to process. Use of templates expedite the generation of models and presentations. These template files may reside on the local file structure of the server, as follows:

```
~/XamlConfig/
    Templates_S/
    Templates_P/
    xsltFiles/
        calcXml/
        presXml/
        resXml/
```

The template files fall into three categories:

*.calc.*: templates or XSLT files for generating calculation engine 104 executable instructions; *.pres.*: templates or XSLT files for generating presentation engine 105 executable instructions; and *.res.*: XSLT files for generating responses to be returned to the caller.

At least three files are required in order to use the calculation engine 104 and presentation engine 105, in the preferred embodiment—one master file 108 and two files 107. The first XSLT file 108 generates the instructions to be processed and the second XSLT file transforms the XML document into a response suitable for the caller. The two files 107 inform what is to be done from the calculation and presentation perspectives, respectively. Spreadsheet templates 106 and presentation templates 109 may also be employed, but are not necessary, to build the desired output product.

However, it is an efficient use of the described system to use one or more templates in the calculation engine 104 or presentation engine 105 tier to expedite the processing of the request. To this end, there is a referential structure and set of standards employed to simplify the configuration and support of a configured workflow.

A unique name for the model is used. From the previous example, “FamLimPar2_{—}1” is a unique name for the model. It is used to identify uniquely all resources employed in generating this model. The map entry is identified by the name, and the associated XSLT files are named accordingly, as follows:

<map id=“ FamLimPar2_1” modelId=“id” userId=“name”
organization=“organization”>
<transform processor=“~\xsltFiles\calcXml\ FamLimPar2_1.calc.xsl”
target=“calc1” />
<calc name=“calc1” ></calc>
<transform processor=“~\xsltFiles\presXml\ FamLimPar2_1.pres.xsl”
target=“pres1”/>
<pres name=“pres1”></pres>
<transform processor=“~\xsltFiles\resXml\ FamLimPar2_1.res.xsl”
target=“res”/>
</map>

Following the naming convention, ˜\xsltFiles\calcXml\FamLimPar2_{—}1.calc.xsl″ will generate instructions for the calculation engine 104, ˜\xsltFiles\calcXml\FamLimPar2_{—}1.pres.xsl″ will generate instructions for the presentation engine 105 and ˜\xsltFiles\calcXml\FamLimPar2_{—}1.res.xsl″ will produce the response XML document for the caller.

Within ˜\xsltFiles\calcXml\FamLimPar2_{—}1.calc.xsl″

```
...
<xsl:param name=“SYSPmodelRoot” />
<xsl:param name=“SYSPxlsTmplts” />
...
<xsl:param name=“client” />
<xsl:variable name=“input” ><xsl:value-of select=“$SYSPxlsTmplts”
/><xsl:value-of
select=“//map/@id” />.calc.xls</xsl:variable>
...
    <xsl:template match=“//calc[@name=‘calc1’]” >
        <calc>
            <xsl:attribute name=“name”>calc1</xsl:attribute>
            <xsl:attribute name=“input”><xsl:value-of select=“$input”
            /></xsl:attribute>
```

The head of the files defines the xsl:param elements that are used to subscribe to the externally loaded input fields and system constants as described in the XML meta-language translator/interpreter 103. The SYSPxlsTmplts refers to the amlconfig.xml defined root for the calculation engine 104 template root. Thus, the input attribute that will be used to locate the template points to the appropriate directory. The next xsl:value element identifies the <map> element's id attribute, id=“FamLimPar2_{—}1”, as the name of the template file appended to .calc.xls. Thus, when the entire statement is evaluated, the input attribute of the calc element will evaluate to “˜/XamlConfig/Templates_S/FamLimPar2_{—}1..calc.xls”. This same line of logic is followed through the FamLimPar2_{—}1.pres.xsl file, which uses the same syntax to identify the “˜/XamlConfig/Templates_S/FamLimPar2_{—}1..pres.pot” file for the presentation engine 105.

The form of the response document conforms to the response desired for return to the caller. The only rule to be held constant is that all documents are stored locally and, in some cases, cached on a network share in a file path. When returning meta-data for retrieving resources produced by the system, this is the format of the path that will precede all resources.

The following provides a summary of the manner in which new models can be configured. A new <map> entry is created that defines at least two <transforms> elements and one <pres> or <calc> element. The files follow the referential structure named to maintain flexibility and convention. All templates/XSLT files are placed in the appropriate directories. The last <transform> element references a *.res.xsl file for returning the result to the caller.

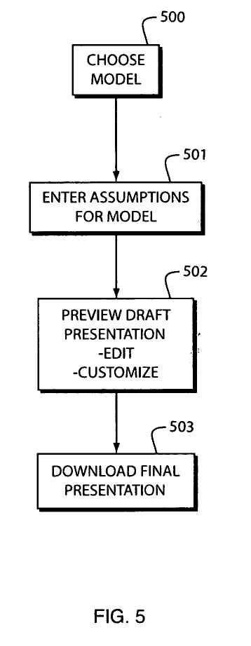

With reference to FIG. 5, a flow chart is presented, illustrating the steps undertaken by a user in employing the system of the present invention. In step 500, the user chooses a model of interest and, in step 501, the user enters the assumptions required for the model. In step 502, the system allows the user to preview the draft presentation generated based on the model chosen and the assumptions entered. In this step, the user may delete slides that are not required, or provide other customizations. When the user is satisfied with the form of the presentation, he may download the final version of the presentation in step 503.

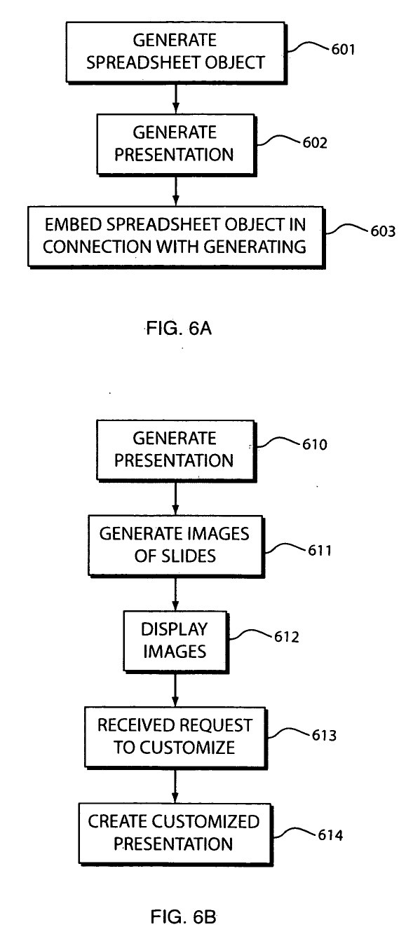

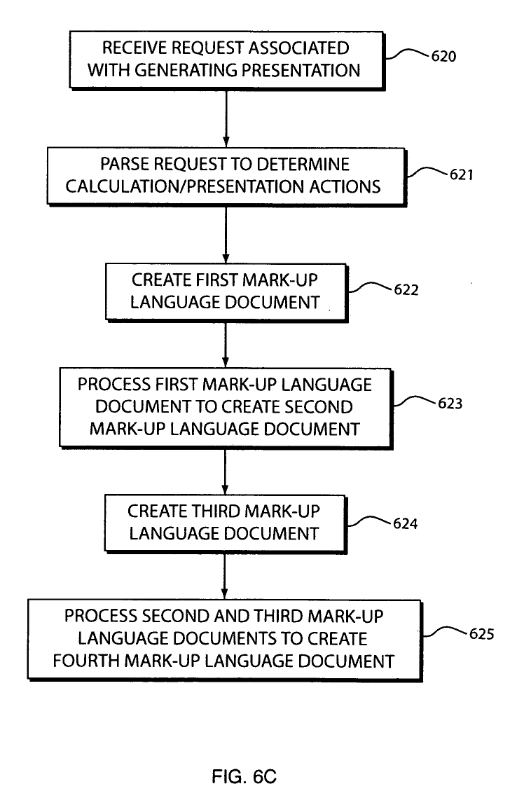

With reference to FIGS. 6A, 6B and 6C, several methods of the present invention are illustrated.

With reference to FIG. 6A, a method for generating a presentation is illustrated. A spreadsheet object is generated in step 601. The presentation is generated in step 602. In step 603, the spreadsheet object is embedded in the presentation.

With reference to FIG. 6B, a method for customizing a presentation is illustrated. The presentation is generated in step 610. The presentation comprises one or more slides. An image of each of one or more of the slides is generated 611. One or more of the images is displayed in step 612. One or more requests to customize the presentation are received in step 613. The customized presentation is created in step 614.

With reference to FIG. 6C, a method for generating a presentation is illustrated. A request associated with generating a presentation is received in step 620. The request is parsed, in step 621, to determine one or more calculation actions and one or more presentation actions to be taken in connection with generating the presentation. A first mark-up language document is created, in step 622, comprising executable instructions indicating calculation actions. The first mark-up language document is processed, in step 623, to create a second mark-up language document comprising calculation data. A third mark-up language document comprising executable instructions indicating presentation actions is created in step 624. The third mark-up language document and the second mark-up language document are processed, in step 625, to create a fourth mark-up language document comprising data associated with one of a draft presentation and a final presentation. One or more spreadsheet templates may be employed in connection with creating the second mark-up language document. One or more presentation templates may be employed in connection creating the fourth mark-up language document.

One or more of the foregoing steps may be executed by software running on a data-processing apparatus.

What is claimed is:

1. A method for generating a presentation comprising:
generating a spreadsheet object;
generating the presentation; and
embedding the spreadsheet object in the presentation in connection with generating the presentation.

2. A method for customizing a presentation comprising:
generating the presentation, wherein the presentation comprises one or more slides;
generating an image of one or more of the slides;
displaying one or more of the images;
receiving one or more requests to customize the presentation; and
creating a customized presentation.

3. The method of claim 2 wherein one or more spreadsheet objects are embedded in the presentation.

4. The method of claim 2 wherein said requests comprise one or more of: a request to remove one or more of the slides from the presentation, a request to add text elements, a request to add one or more additional slides to the presentation, and a request to change a numbering convention associated with the slides.

5. A method for generating a presentation comprising:
receiving a request associated with generating a presentation;
parsing the request to determine one or more calculation actions and one or more presentation actions to be taken in connection with generating the presentation;
creating a first mark-up language document comprising executable instructions indicating calculation actions;
processing the first mark-up language document to create a second mark-up language document comprising calculation data;
creating a third mark-up language document comprising executable instructions indicating presentation actions; and
processing the third mark-up language document and the second mark-up language document to create a fourth mark-up language document comprising data associated with one of a draft presentation and a final presentation.

6. The method of claim 5 further comprising:
employing one or more spreadsheet templates in connection with creating the second mark-up language document.

7. The method of claim 5 further comprising:
employing one or more presentation templates in connection with creating the fourth mark-up language document.

8. A system for generating a presentation comprising:
a calculation engine for generating a spreadsheet object; and
a presentation engine for generating the presentation,
wherein, in connection with generating the presentation, the spreadsheet object is embedded in the presentation.

9. A system for customizing a presentation comprising:
a presentation engine for generating the presentation, wherein the presentation comprises one or more slides;
wherein an image of one or more of the slides is generated; one or more of the images are displayed; one or more requests to customize the presentation are received; and a customized presentation is created.

10. The system of claim 9 wherein one or more spreadsheet objects are embedded in the presentation.

11. The system of claim 9 wherein said requests comprise one or more of: a request to remove one or more of the slides from the presentation, a request to add text elements, a request to add one or more additional slides to the presentation, and a request to change a numbering convention associated with the slides.

12. A system for generating a presentation comprising:
a workflow engine for receiving a request associated with generating a presentation; parsing the request to determine one or more calculation actions and one or more presentation actions to be taken in connection with generating the presentation; and creating a first mark-up language document comprising executable instructions indicating calculation actions;
a calculation engine for receiving the first mark-up language document and processing the first mark-up language document to create a second mark-up language document comprising calculation data; the workflow engine further for receiving the second mark-up language document, processing the second mark-up language document, and creating a third mark-up language document comprising executable instructions indicating presentation actions; and
a presentation engine for receiving the third mark-up language document and processing the third mark-up language document to create a fourth mark-up language document comprising data associated with one of a draft presentation and a final presentation.

13. The system of claim 12 wherein one or more spreadsheet templates are employed in connection with creating the second mark-up language document.

14. The system of claim 12 further wherein one or more presentation templates are employed in connection with creating the fourth mark-up language document.

15. A computer-readable medium comprising instructions which, when executed on a data processing apparatus, perform a method for generating a presentation comprising:
generating a spreadsheet object;
generating the presentation; and
embedding the spreadsheet object in the presentation in connection with generating the presentation.

16. A computer-readable medium comprising instructions which, when executed on a data processing apparatus, perform a method for customizing a presentation comprising:
generating the presentation, wherein the presentation comprises one or more slides;
generating an image of one or more of the slides;
displaying one or more of the images;
receiving one or more requests to customize the presentation; and
creating a customized presentation.

17. The computer-readable medium of claim 16 wherein one or more spreadsheet objects are embedded in the presentation.

18. The computer-readable medium of claim 16 wherein said requests comprise one or more of: a request to remove one or more of the slides from the presentation, a request to add text elements, a request to add one or more additional slides to the presentation, and a request to change a numbering convention associated with the slides.

19. A computer-readable medium comprising instructions which, when executed on a data processing apparatus, perform a method for processing a request associated with generating a presentation comprising:
parsing the request to determine one or more calculation actions and one or more presentation actions to be taken in connection with generating the presentation;
creating a first mark-up language document comprising executable instructions indicating calculation actions;
processing the first mark-up language document to create a second mark-up language document comprising calculation data;
creating a third mark-up language document comprising executable instructions indicating presentation actions; and
processing the third mark-up language document and the second mark-up language document to create a fourth mark-up language document comprising data associated with one of a draft presentation and a final presentation.

20. The method of claim 19 further comprising:
employing one or more spreadsheet templates in connection with creating the second mark-up language document.

21. The method of claim 19 further comprising:
employing one or more presentation templates in connection with creating the fourth mark-up language document.

22. A presentation created by a method comprising the steps of:
generating a spreadsheet object;
generating the presentation; and
embedding the spreadsheet object in the presentation in connection with generating the presentation.

23. A customized presentation created by a method comprising the steps of:
generating the presentation, wherein the presentation comprises one or more slides;
generating an image of one or more of the slides;
displaying one or more of the images;
receiving one or more requests to customize the presentation; and
creating a customized presentation.

24. The customized presentation of claim 23 wherein one or more spreadsheet objects are embedded in the presentation.

25. The customized presentation of claim 23 wherein said requests comprise one or more of: a request to remove one or more of the slides from the presentation, a request to add text elements, a request to add one or more additional slides to the presentation, and a request to change a numbering convention associated with the slides.

26. A presentation created by a method comprising the steps of:
receiving a request associated with generating the presentation;
parsing the request to determine one or more calculation actions and one or more presentation actions to be taken in connection with generating the presentation;
creating a first mark-up language document comprising executable instructions indicating calculation actions;
processing the first mark-up language document to create a second mark-up language document comprising calculation data;
creating a third mark-up language document comprising executable instructions indicating presentation actions; and
processing the third mark-up language document and the second mark-up language document to create a fourth mark-up language document comprising data associated with one of a draft presentation and a final presentation.

27. The presentation of claim 26 wherein the method further comprises:
employing one or more spreadsheet templates in connection with creating the second mark-up language document.

28. The presentation of claim 26 wherein the method further comprises:
employing one or more presentation templates in connection with creating the fourth mark-up language document.
